(19) United States
(12) Patent Application Publication
(10) Pub. No.: US 2001/0002560 A1
(43) Pub. Date: Jun. 7, 2001

(54) METHOD OF SWITCHING CUTTING KNIFE ARRANGEMENTS

(76) Inventor: MASASHI AOKI, MINAMIASHIGARA-SHI (JP)

Correspondence Address: SUGHRUE MION ZINN MACPEAK & SEAS, 2100 PENNSYLVANIA AVE NW, WASHINGTON, DC, 20037

(21) Appl. No.: 08/808,181

(22) Filed: Feb. 28, 1997

(30) Foreign Application Priority Data
Mar. 8, 1996 (JP) 51511/1996

(51) Int. Cl. B26D 1/15

(52) U.S. Cl. 83/13; 83/499

(57) ABSTRACT

A slitter slits a wide sheet into a plurality of narrow strips by use of a plurality of cutting knives mounted on a shaft extending in a direction substantially normal to the direction in which the wide sheet is fed. Cutting knife arrangements are switched by controlling a knife moving mechanism to move the cutting knives along the shaft so that one of n-sorts of cutting knife arrangements in each of which the cutting knives are arranged in regular intervals is obtained. n-sets of knife positioning programs each for moving the cutting knives from respective origin positions to positions for the corresponding cutting knife arrangement and n-sets of knife returning programs each for returning the cutting knives from positions for the corresponding cutting knife arrangement to the respective origin positions are stored in a memory. When the knife arrangements are switched from a first knife arrangement to a second knife arrangement, the cutting knives are once returned to the respective origin positions according to the knife returning program for the first knife arrangement and then moved to the positions for the second knife arrangement according to the knife positioning program for the second knife arrangement.

### BACKGROUND OF THE INVENTION

1. Field of the Invention

This invention relates to a method of switching arrangements of cutting knives to change the slitting width in a slitter for slitting a wide sheet into a plurality of narrow strips by a plurality of cutting knives arranged at predetermined intervals, and more particularly to a method of switching arrangements of such cutting knives which can easily attend to requirement toward an additional arrangement of the cutting knives.

2. Description of the Related Art

There has been known a slitter for slitting a wide sheet into a plurality of narrow strips by use of a plurality of cutting knives mounted on a shaft extending in a direction substantially normal to the direction in which the wide sheet is fed, as disclosed, for instance, in Japanese Unexamined Patent Publication Nos. 63(1988)-134193 and 3(1991)-245995.

In a slitter of this type, the slitting width can be changed by changing the arrangement of cutting knives by moving the cutting knives along the shaft so that the spaces among the knives vary. Recently there has been proposed a slitted in which the arrangement of the cutting knives can be automatically changed and examples of systems for switching the arrangement of the cutting knives are disclosed in the patent publications described above.

As disclosed in the patent publications, when the arrangement of the knives is automatically switched, generally the knives are directly moved from a position for a given cutting width to a position for another cutting width. For example, assuming that each cutting knife is set in positions a, b and c for respective cutting widths A, B and C, any change in slitting width can be dealt with by controlling the knife moving means to be able to move each knife from any one of the positions a, b and c to either of the other two positions.

As means for controlling the knife moving means, one storing therein six programs for moving each knife from position a to position b, from position a to position c, from position b to position c, from position b to position a, from position c to position a and from position c to position b can be suitably employed.

However in such a system where each of the cutting knives is moved directly from a position to another according to a predetermined program, there is a problem that it is difficult to attend to requirement toward an additional arrangement of the cutting knives.

That is, assuming that M sorts of slitting widths are required, programs for moving the cutting knives from M sorts of positions to the other positions, which number in (M−1), are necessary and accordingly M•(M−1) sets of programs are necessary in total. When one slitting width is to be added, (M+1)•M sets of programs become necessary and the number of programs to be created is (M+1)•M−M•(M−1) (=2M).

For example, in the case of a slitter for slitting photographic materials, sorts of slitting widths sometimes number in 40 and when one sort of slitting width is to be added, another 80 sets of programs for controlling the knife moving means must be created. Further when new programs are created, control actions based on the programs must be checked and the accuracy of each control action must be checked. Thus setting an additional knife arrangement has conventionally required a long time.

### SUMMARY OF THE INVENTION

In view of the foregoing observations and description, the primary object of the present invention is to provide a method of switching arrangements of cutting knives which can easily attend to requirement toward an additional arrangement of the cutting knives.

In accordance with a first aspect of the present invention, setting of an additional arrangement of the cutting knives is facilitated by switching arrangements of the cutting knives from a first arrangement to a second arrangement by moving each cutting knife from a position for the first arrangement once to an origin position and then to another position for the second arrangement.

That is, in accordance with the first aspect of the present invention, there is provided, in a slitter for slitting a wide sheet into a plurality of narrow strips by use of a plurality of cutting knives mounted on a shaft extending in a direction substantially normal to the direction in which the wide sheet is fed, a method of switching cutting knife arrangements comprising the step of controlling a knife moving means to move the cutting knives along the shaft so that one of n-sorts of cutting knife arrangements in each of which the cutting knives are arranged in regular intervals is obtained, wherein the improvement comprises that n-sets of knife positioning programs each for moving the cutting knives from respective origin positions to positions for the corresponding cutting knife arrangement and n-sets of knife returning programs each for returning the cutting knives from positions for the corresponding cutting knife arrangement to the respective origin positions are stored in a memory, and when the cutting knife arrangements are switched from a first cutting knife arrangement to a second cutting knife arrangement, the cutting knives are once returned to the respective origin positions according to the cutting knife returning program for the first cutting knife arrangement and then moved to the positions for the second cutting knife arrangement according to the cutting knife positioning program for the second cutting knife arrangement.

In the method of the first aspect, when the cutting knife arrangements are switched from a first arrangement to a second arrangement, the cutting knives are once returned to the respective origin positions according to the cutting knife returning program for the first arrangement and then moved to the positions for the second arrangement according to the cutting knife positioning program for the second arrangement. Accordingly, addition of one cutting knife arrangement can be attended to by creating only two sets of programs, that is, a cutting knife returning program and a cutting knife positioning program.

This can be said irrespective of the total number of the cutting knife arrangements. For example, when one cutting knife arrangement is to be added to forty cutting knife arrangements, the number of programs to be created may be only 2/80=1/40 as compared with the conventional method.

In accordance with a second aspect of the present invention, setting of an additional arrangement of the cutting knives is facilitated by executing a program for controlling the knife moving means in combination with operation.

That is, in accordance with the second aspect of the present invention, there is provided, in a slitter for slitting a wide sheet into a plurality of narrow strips by use of a plurality of cutting knives mounted on a shaft extending in a direction substantially normal to the direction in which the wide sheet is fed, a method of switching cutting knife arrangements comprising the step of controlling a knife moving means to move the cutting knives along the shaft so that one of n-sorts of cutting knife arrangements in each of which the cutting knives are arranged in regular intervals is obtained, wherein the improvement comprises that a set of program for controlling the knife moving means to move the cutting knives from one position to another along the shaft on the basis of given position information on positions from and to which the cutting knives are to be moved and order information on moving order in which the cutting knives are to be moved in sequence is stored in a memory, and when the cutting knife arrangements are switched from a first cutting knife arrangement to a second cutting knife arrangement, position information and order information calculated on the basis of the first and second cutting knife arrangements are given to said program and the knife moving means is controlled on the basis of the program to move the cutting knives to positions for the second cutting knife arrangement.

In the method of the second aspect, addition of one cutting knife arrangement to M sorts of arrangements can be attended to by calculating M sets of position information and moving order information for moving the cutting knives from the positions for the new arrangement to the positions for the M sorts of arrangements and M sets of position information and moving order information for moving the cutting knives from the positions for the M sorts of arrangements to the positions for the new arrangement. That is, addition of one cutting knife arrangement to M sorts of arrangements can be attended to by only calculating 2M sets of position information and moving order information.

Calculation of 2M sets of position information and moving order information is much easier than creation of 2M sets of programs for moving the cutting knives. Thus also in accordance with the second aspect, setting of an additional arrangement of the cutting knives is facilitated.

Specifically, it has been taken about one day to add a cutting knife arrangement to forty sorts of arrangements in the conventional method. To the contrast, according to the method of the first or second aspects of the present invention, the time can be shortened to about one hour.

### BRIEF DESCRIPTION OF THE DRAWINGS

FIG. 1 is a schematic side view showing an example of slitter to which the method of the present invention is applied,

FIG. 2 is a schematic front view showing a part of the slitter,

FIG. 3 is a view for illustrating procedure of switching arrangement of cutting knives in accordance with a method a first embodiment of the present invention,

FIG. 4 is a view for illustrating procedure of switching arrangement of cutting knives in accordance with a method a second embodiment of the present invention,

FIG. 5 is a flow chart for illustrating initialization of positions of cutting knives, and

FIGS. 6 to 9 are flow charts for illustrating processing for obtaining positions to which the respective cutting knives are to be moved and order in which the cutting knives are moved in accordance with the second embodiment of the present invention.

### DESCRIPTION OF THE PREFERRED EMBODIMENTS

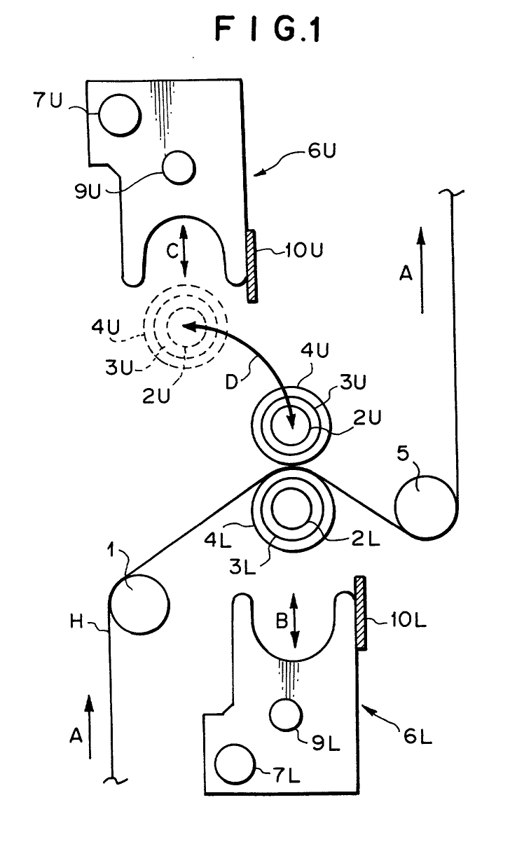

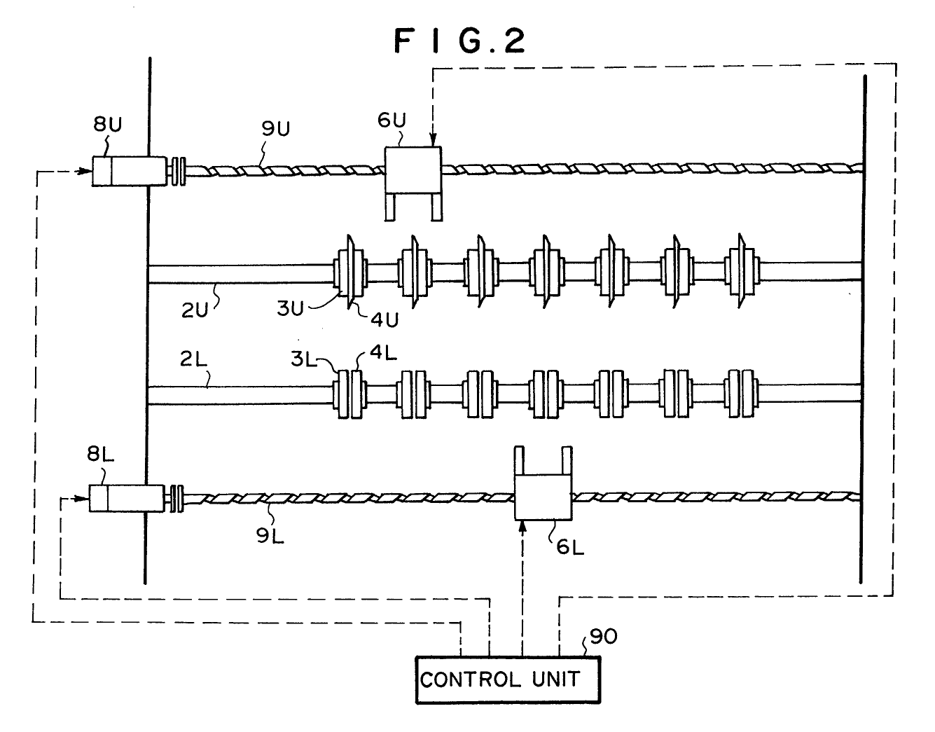

A method of switching the arrangements of cutting knives in accordance with a first embodiment of the present invention will be described, hereinbelow. The method of the present invention is applied to, for instance, a slitter shown in FIGS. 1 and 2. In FIGS. 1 and 2, a slitter comprises a pair of pass rollers 1 and 5 around which a wide sheet H in a continuous length such as raw web of photographic paper is passed, a feeding means (not shown) for feeding the wide sheet H in the direction of arrow A in FIG. 1, upper and lower shafts 2U and 2L which extend substantially normal to the feeding direction of the wide sheet H respectively above and below thereof, a plurality of upper and lower knife holders 3U and 3L (e.g., seven each) respectively mounted on the upper and lower shafts 2U and 2L to be movable along the shafts, and a plurality of upper and lower knives 4U and 4L respectively mounted on the upper and lower knife holders 3U and 3L.

A lower knife moving mechanism 6L is disposed below the lower shafts 2L to be movable up and down in the direction of arrow B. The upper shaft 2U is rotated by a rotating mechanism (not shown) in the direction of arrow D between a cutting position shown by the solid line in FIG. 1 and a retracted position shown by the broken line. An upper knife moving mechanism 6U is disposed above the retracted position of the upper shaft 2U to be movable up and down in the direction of arrow C.

The lower knife moving mechanism 6L is fitted on a guide shaft 7L, extending in parallel the upper and lower shafts 2U and 2L, to be slidable along the guide shaft 7L. The lower knife moving mechanism 6L is in mesh with a threaded shaft 9L and is slid back and forth along the guide shaft 7L in response to rotation of a motor 8L. Similarly the upper knife moving mechanism 6U is fitted on a guide shaft 7U, extending in parallel the upper and lower shafts 2U and 2L, to be slidable along the guide shaft 7U and at the same time is in mesh with a threaded shaft 9U and is slid back and forth along the guide shaft 7U in response to rotation of a motor 8U. In FIG. 2, the guide shafts 7U and 7L are omitted.

A holder detecting means 10L for detecting the lower knife holder 3L is mounted on the lower knife moving mechanism 6L and a holder detecting means 10U for detecting the upper knife holder 3U is mounted on the upper knife moving mechanism 6U. The holder detecting means 10L and 10U may comprise, for instance, a photoelectric tube, a contactless switch or a limit switch.

The upper knives 4U are arranged at regular intervals on the upper shaft 2U and the lower knives 4L are disposed in contact with the corresponding upper knives 4U in said cutting position. While the upper and lower shafts 4U and 4L are rotated to rotate the upper and lower knives 4U and 4L, the wide sheet H is fed between the upper and lower knives 4U and 4L, whereby the wide sheet H is slit into a plurality of narrow strips.

The slitting width of the wide sheet H or the widths of the strips are determined by the intervals between the cutters each formed by the upper and lower knives 4U and 4L. Accordingly by switching the arrangements of the cutters so that the intervals between the cutters change, the slitting widths can be changed. The arrangements of the cutters are basically switched in the following manner.

When the arrangements of the upper knives 4U are switched, the upper shaft 2U is rotated to the retracted position and then the motor 8U is energized to rotate the threaded shaft 9U, thereby moving the upper knife moving mechanism 6U in the longitudinal direction of the threaded shaft 9U. A control unit 90 which may comprise, for instance a microcomputer, controls the motor 8U to control the movement of the upper knife moving mechanism 6U. When the holder detecting means 10U of the upper knife moving mechanism 6U detects one of the upper knife holders 3U, that is, when the upper knife moving mechanism 6U comes to be aligned with one of the upper knife holders 3U, the control unit 90 stops the motor 8U.

Then the upper knife moving mechanism 6U is moved to a predetermined position close to the upper shaft 2U and is brought into engagement with the upper knife holder 3U. Then the upper knife moving mechanism 6U releases the upper knife holder 3U from the upper shaft 2U and the control unit 90 drives the motor 8U to move the upper holder 3U along the upper shaft to a predetermined position by way of the upper knife moving mechanism 6U. Thereafter the upper knife moving mechanism 6U fixes the upper knife holder 3U (accordingly the upper knife 4U) to the upper shaft 2 and then moves away from the upper shaft 2U. The other upper knife holders 3U are moved along the upper shaft 2U and fixed to the upper shaft 2U in the same manner.

The operation of the upper knife moving mechanism 6U described above is also controlled by the control unit 90. The mechanism for releasably fixing the upper knife holders 3U to the upper shaft 2U and the mechanism for fixing and releasing the upper knife holders 3U to and from the upper shaft 2U may comprise, for instance, those disclosed in Japanese Unexamined Patent Publication No. 3(1991)-245995.

The arrangements of the lower knives 4L are switched in the same manner except that the lower shaft 2L is not moved and accordingly will not be described here.

A control for switching the arrangements of the cutters from one arrangement (the current arrangement) to another arrangement (next arrangement) will be described, hereinbelow. The following description will be made assuming that each cutter is set in one of positions a, b and c and only on switching of positions of the upper knives 4U. Switching of positions of the lower knives 4L may be made in the similar manner.

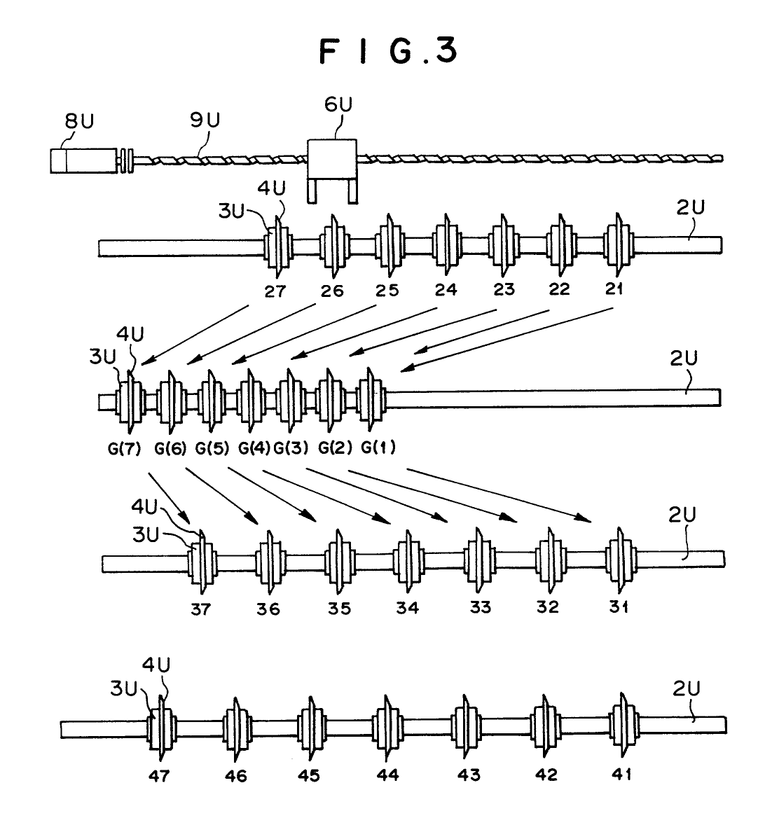

In FIG. 3, the upper knives 4U on the uppermost upper shaft 2U are in position a, those on the second uppermost upper shaft 2U are in origin position, those on the second lowermost upper shaft 2U are in position b and those on the lowermost upper shaft 2U are in position c. Reference numerals 21 to 27, 31 to 37, 41 to 47 and G(1) to G(7) denote positions of the upper knife holders 3U. G(1) to G(7) denote origin positions.

The control unit 90 stores in a memory thereof following six sets of programs 11 to 16.

Program 11 (origin position→position a)

\mathring{1}To move the upper knife holder 3U in origin position G(1) to position 21.

\mathring{2}To move the upper knife holder 3U in origin position G(2) to position 22.

\mathring{3}To move the upper knife holder 3U in origin position G(3) to position 23.

\mathring{4}To move the upper knife holder 3U in origin position G(4) to position 24.

\mathring{5}To move the upper knife holder 3U in origin position G(5) to position 25.

\mathring{6}To move the upper knife holder 3U in origin position G(6) to position 26.

\mathring{7}To move the upper knife holder 3U in origin position G(7) to position 27.

Program 12 (position a→origin position)

\mathring{1}To move the upper knife holder 3U in position 27 to origin position G(7).

\mathring{2}To move the upper knife holder 3U in position 26 to origin position G(6).

\mathring{3}To move the upper knife holder 3U in position 25 to origin position G(5).

\mathring{4}To move the upper knife holder 3U in position 24 to origin position G(4).

\mathring{5}To move the upper knife holder 3U in position 23 to origin position G(3).

\mathring{6}To move the upper knife holder 3U in position 22 to origin position G(2).

\mathring{7}To move the upper knife holder 3U in position 21 to origin position G(l).

Program 13 (origin position→position b)

\mathring{1}To move the upper knife holder 3U in origin position G(1) to position 31.

\mathring{2}To move the upper knife holder 3U in origin position G(2) to position 32.

\mathring{3}To move the upper knife holder 3U in origin position G(3) to position 33.

\mathring{4}To move the upper knife holder 3U in origin position G(4) to position 34.

\mathring{5}To move the upper knife holder 3U in origin position G(5) to position 35.

\mathring{6}To move the upper knife holder 3U in origin position G(6) to position 36.

\mathring{7}To move the upper knife holder 3U in origin position G(7) to position 37.

Program 14 (position b→origin position)

\mathring{1}To move the upper knife holder 3U in position 37 to origin position G(7).

\mathring{2}To move the upper knife holder 3U in position 36 to origin position G(6).

\mathring{3}To move the upper knife holder 3U in position 35 to origin position G(5).

\mathring{4}To move the upper knife holder 3U in position 34 to origin position G(4).

\mathring{5}To move the upper knife holder 3U in position 33 to origin position G(3).

\mathring{6}To move the upper knife holder 3U in position 32 to origin position G(2).

\mathring{7}To move the upper knife holder 3U in position 31 to origin position G(1).

Program 15 (origin position→position c)

\mathring{1}To move the upper knife holder 3U in origin position G(1) to position 41.

\mathring{2}To move the upper knife holder 3U in origin position G(2) to position 42.

\mathring{3}To move the upper knife holder 3U in origin position G(3) to position 43.

\mathring{4}To move the upper knife holder 3U in origin position G(4) to position 44.

\mathring{5}To move the upper knife holder 3U in origin position G(5) to position 45.

\mathring{6}To move the upper knife holder 3U in origin position G(6) to position 46.

\mathring{7}To move the upper knife holder 3U in origin position G(7) to position 47.

Program 16 (position c→origin position)

\mathring{1}To move the upper knife holder 3U in position 47 to origin position G(7).

\mathring{2}To move the upper knife holder 3U in position 46 to origin position G(6).

\mathring{3}To move the upper knife holder 3U in position 45 to origin position G(5).

\mathring{4}To move the upper knife holder 3U in position 44 to origin position G(4).

\mathring{5}To move the upper knife holder 3U in position 43 to origin position G(3).

\mathring{6}To move the upper knife holder 3U in position 42 to origin position G(2).

\mathring{7}To move the upper knife holder 3U in position 41 to origin position G(1).

The programs 11, 13 and 15 are knife positioning programs for moving the upper knife holders 3U from respective origin positions to positions a, b and c, and the programs 12, 14 and 16 are knife returning programs for returning the upper knife holders 3U from positions a, b and c to the respective origin positions. Further the numbers \mathring{1}to \mathring{7}in each program designates the order in which the holders 3U are moved. For example, in program 11, the upper knife holder 3U in origin position G(l) is first moved to position 21 and then the upper knife holder 3U in origin position G(2) is moved to position 22.

When instruction to switch from the current arrangement of the upper knives 4U to a next arrangement of the upper knives 4U is given, the control unit 90 returns all the upper knife holders 3U to the respective origin positions according to the knife returning program corresponding to the current arrangement and then moves the upper knife holders 3U to the positions for the next arrangement according to the knife positioning program corresponding to the next arrangement. For example, when instruction to move the upper knives 4U to position b is given when the upper knives 4U are in position a, the control unit 90 first executes program 12 and then executes program 13.

When the upper knives 4U are moved from position a to position b via the origin position, the time required to switch the arrangement of the upper knives 4U is somewhat elongated as compared with the case where the upper knives 4U are moved from position a directly to position b. However requirement toward an additional arrangement of the cutting knives can be easily attended to. That is, when position d of the upper knives 4U is to be added, such requirement can be attended to by creating only two programs, a knife positioning program for moving the upper knife holders 3U from origin position to position d and a knife returning program for returning the upper knife holders 3U from position d to the origin position. To the contrast, when the upper knives 4U are moved from one position directly to another, it is necessary to create six more programs in order to attend to addition of one arrangement of the upper knives 4U as described before.

A method of switching the arrangements of cutting knives in accordance with a second embodiment of the present invention will be described, hereinbelow. The method of the second embodiment is also applied to the slitter shown in FIGS. 1 and 2. Further description will be made only on switching of positions of the upper knives 4U.

In the second embodiment, the control unit 90 stores in a memory thereof following one set of program 20.

Program 20

\mathring{1}To move the upper knife holder 3U in position W(1) to position Z(1).

\mathring{2}To move the upper knife holder 3U in position W(2) to position Z(2).

\mathring{3}To move the upper knife holder 3U in position W(3) to position Z(3).

\mathring{4}To move the upper knife holder 3U in position W(4) to position Z(4).

\mathring{5}To move the upper knife holder 3U in position W(5) to position Z(5).

\mathring{6}To move the upper knife holder 3U in position W(6) to position Z(6).

\mathring{7}To move the upper knife holder 3U in position W(7) to position Z(7).

When instruction to switch slitting widths is given, an arithmetic means such as a sequencer, a computer or the like in the control unit 90 operates absolute positions X(N) of the upper knives 4U in the current positions (positions for the current slitting width) and the absolute positions Y(N) of the upper knives 4U in the next positions (positions for the next slitting width) and transfers data on the absolute positions to program 20.

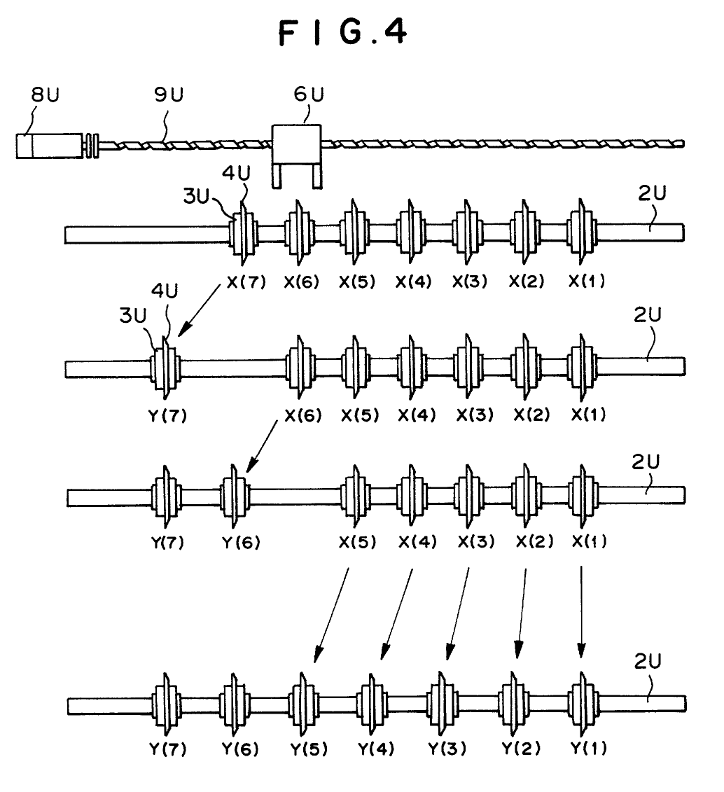

Though will be described in detail later, the absolute positions X(N) and Y(N) are basically obtained in the following manner. That is, absolute position X(N) is given as a function of knife order N, the current slitting width A, the next slitting width B and the number of knives currently used S1, X(N)=f{A, B, N, S1}, and absolute position Y(N) is given as a function of knife order N, the current slitting width A, the next slitting width B and the number of knives to be used next S2, Y(N)=f{A, B, N, S2}. Absolute position X(N) and Y(N) are defined as distances from the left end of the upper shaft 2U as seen in FIG. 4. Accordingly, the position of the upper knife 4U is more rightward in FIG. 4 as the value of absolute position X(N) or Y(N) increases.

The uppermost one of the upper shafts 2U shown in FIG. 4 shows the state where all the upper knives 4U are in position a and lowermost one of the upper shafts 2U shown in FIG. 4 shows the state where all the upper knives 4U are in position b. When the upper knives 4U are moved to position b from position a, data on the absolute positions X(N) and Y(N) are transferred to program 20 and the program 20 is converted as follows.

\mathring{1}To move the upper knife holder 3U in absolute position X(7) to absolute position Y(7).

\mathring{2}To move the upper knife holder 3U in absolute position X(6) to absolute position Y(6).

\mathring{3}To move the upper knife holder 3U in absolute position X(5) to absolute position Y(5).

\mathring{4}To move the upper knife holder 3U in absolute position X(4) to absolute position Y(4).

\mathring{5}To move the upper knife holder 3U in absolute position X(3) to absolute position Y(3).

\mathring{6}To move the upper knife holder 3U in absolute position X(2) to absolute position Y(2).

\mathring{7}To move the upper knife holder 3U in absolute position X(1) to absolute position Y(1).

When the program 20 converted as shown above is executed, the upper knife holder 3U (upper knife 4U) in absolute position X(7) is moved to absolute position Y(7) as shown by the second uppermost one of the upper shafts 2U shown in FIG. 4. Then the upper knife holder 3U in absolute position X(6) is moved to absolute position Y(6) as shown by the second lowermost one of the upper shafts 2U shown in FIG. 4. In the similar manner, the seven upper knife holders 3U are moved respectively to absolute position Y(7) to Y(1) as shown by the lowermost one of the upper shafts 2U shown in FIG. 4.

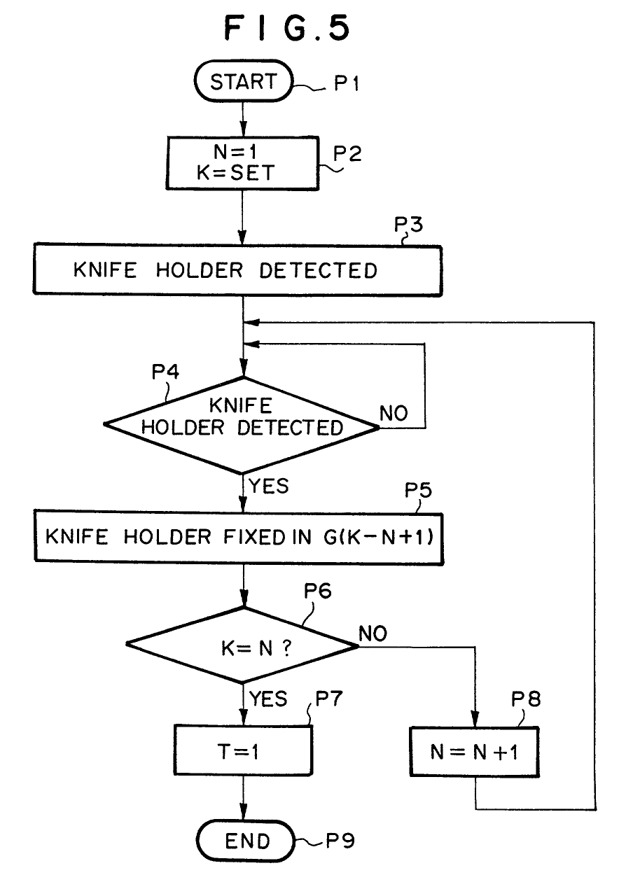

Absolute positions X(1) to X(7) and Y(1) to Y(7) are obtained in the following manner. The following description will be made on a case where one or more of the seven upper knives 4 are sometimes not used in slitting. Initial position setting, that is, processing for setting all the upper knives 4U and 4L to the respective origin positions executed by the control unit 90 will be described first with reference to FIG. 5. The initial position setting for the lower knives 4L is the same as for the upper knives 4U and accordingly the following description is made only on the upper knives 4U.

The processing is started in step P1. Then a pointer N representing the order of an upper knife holder 3U is set to 1 and the number K of the upper knife holders 3U on the upper shaft 2U (seven in this particular embodiment) is set. (step P2) The upper knife holders 3U are detected one by one from the left side as seen in FIG. 4 by the holder detecting means 10U on the upper knife moving mechanism 6U. (step P3) The rightmost upper knife holder 3U as seen in FIG. 3 is kept stationary irrespective of the slitting width.

When one of the upper knife holders 3U is detected, the upper knife holder 3U is moved to origin position G(K−N+1) and fixed there by the upper knife moving mechanism 6U. (steps P4 and P5) K−N+1 stands for the order of origin position as numbered from the right side in FIG. 4 as in FIG. 3. Steps P4 and P5 are repeated until N becomes equal to K with pointer N incremented each time step P5 is performed. (steps P6 and P8) In this manner, the upper knife holders 3U are moved to respective origin positions and fixed there one by one. When all the upper knife holders 3U are fixed to origin positions (K=N in step P6), flag T is set to 1, which represents that the positions of the upper knife holders 3U are initialized. (step P7) Then initialization is ended in step P9.

The initialization described above may also be performed in the preceding embodiment.

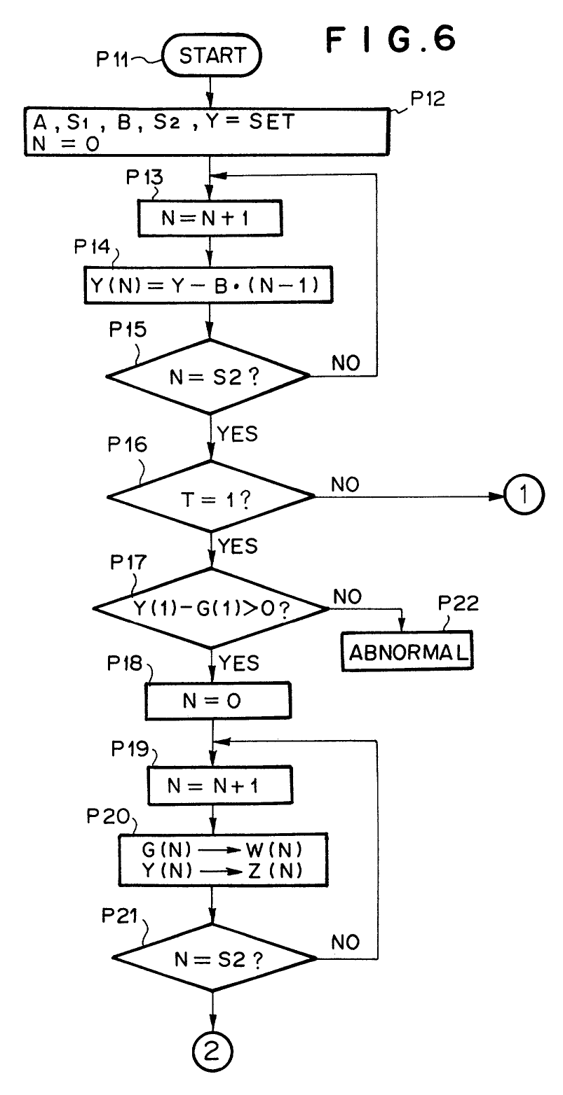

Processing after the initialization will be described with reference to FIGS. 6 to 9, hereinbelow. Processing is started in step P11 in FIG. 6. Then the current slitting width A, the number S1 of knives used for the current slitting width A, the next slitting width B, the number S2 of knives to be used for the next slitting width B and a reference position Y for the knives are set and pointer N representing the order of an upper knife holder 3U is set to 0. (step P12) Then after pointer N is incremented by 1 in step P13, absolute position Y(N) of N-th upper knife holder 3U is obtained on the basis of the reference position Y and the next slitting width B. (step P14) Then it is determined whether N is equal to S2. (step P15) Thus steps P13 to P15 are repeated until N becomes to equal to S2, whereby absolute positions Y(N) for first to S2-th upper knife holders 3U are all obtained.

When it is determined in step P15 that N=S2, it is determined whether flag T=1 in step P16. When it is determined T=1, that is, when the upper knife holders 3U K in number are all fixed to their respective origin positions, it is determined whether Y(1)−G(1)≦0 in order to check whether the system is in normal state. (step P17) When it is determined that Y(1)−G(1)≦0, it is determined that the system in an abnormal state. (step P22)

When it is determined in step P17 that Y(1)−G(1)>0, pointer N is set to 0 in step 18. Then pointer N is incremented by 1 in step P19 and origin positions G(N) and absolute positions Y(N) of first to S2-th upper knife holders 3U are transferred to program 20 as positions W(N) and Z(N) in sequence. (steps P19 to P21)

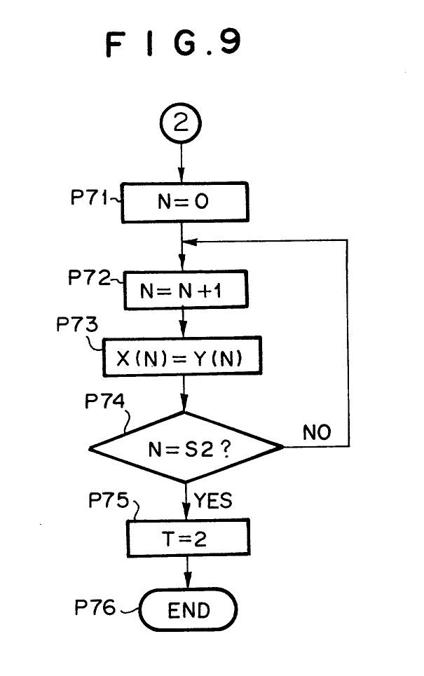

Then processing proceeds to step P71 shown in FIG. 9. In step P71, pointer N is set to 0. Then the absolute positions Y(N) of first to S2-th upper knife holders 3U are stored in sequence as current absolute positions X(N) of first to S2-th upper knife holders 3U. (steps P72 to P74) Thereafter flag T is set to 2, which represents that the upper knife holders 3U are in predetermined positions. The knife position setting processing is ended in step P76.

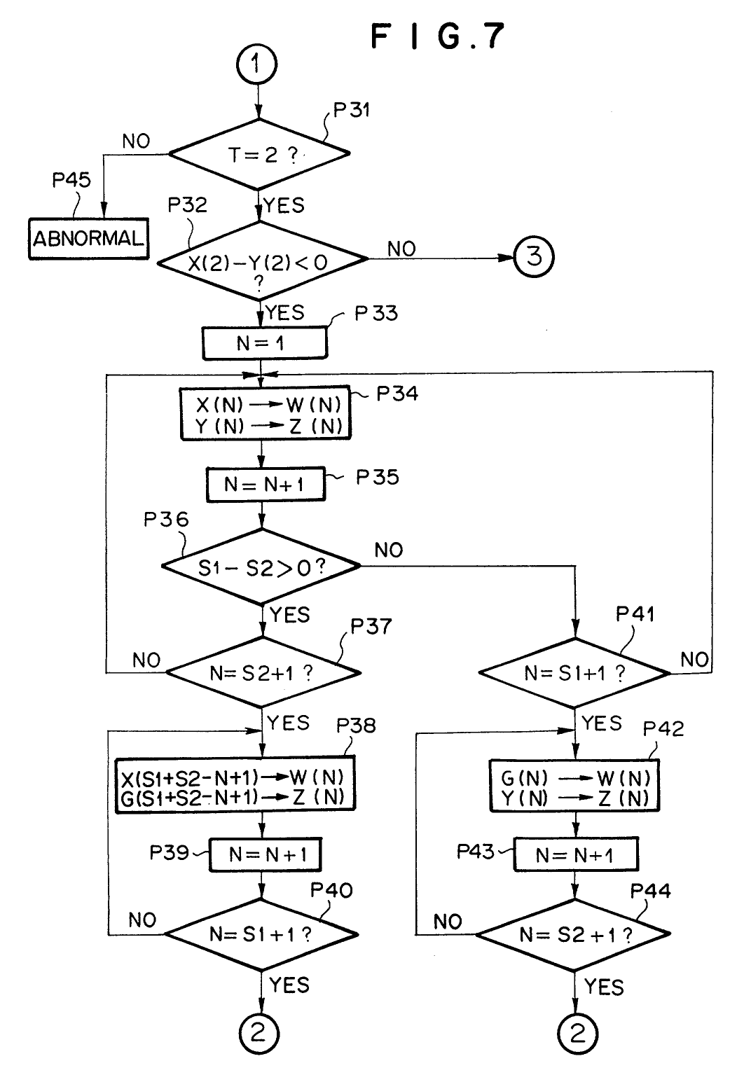

When it is determined that flag T is not 1 in step P16, processing proceeds to step P31 in FIG. 7. In step P31, it is determined whether flag T=2 and when it is determined that flag T is not 2, it is determined in step P45 that the system is in an abnormal state.

When it is determined that flag T is 2, that is, when it is determined that the upper knife holders 3U are in predetermined positions, it is determined whether X(2)−Y(2)<0. (step P32) When it is determined that X(2)−Y(2)<0, that is, in the case of switching where the cutting width is narrowed, pointer N is set to 1 in step P33 and absolute positions X(N) and Y(N) of a desired number of upper knife holders 3U are transferred to program 20 as positions W(N) and Z(N) in sequence in steps P34 and subsequent steps.

That is, absolute positions X(N) and Y(N) of a N-th upper knife holder 3U are transferred to program 20 as positions W(N) and Z(N) in step P34 while incrementing pointer N by 1 in step P35 each time step P34 is performed. In the case of switching where the number of knives used is reduced, that is, S1−S2>0 (step P36), steps P34 and P35 are repeated until N becomes equal to S2+1 (step P37), whereby absolute positions X(N) and Y(N) of first to S2-th upper knife holders 3U are transferred to program 20 in sequence.

In the case of switching where the number of knives used is reduced, after absolute positions X(N) and Y(N) of first to S2-th upper knife holders 3U are transferred to program 20, absolute positions X(S1+S2−N+1) and origin positions G(S1+S2−N+1) of (S2+1)-th to S1-th upper knife holders 3U are transferred to program 20 as positions W(N) and Z(N) in sequence.

That is, absolute positions X(S1+S2−N+1) and origin positions G(S1+S2−N+1) of a (S1+S2−N+1)-th upper knife holder 3U are transferred to program 20 as positions W(N) and Z(N) in step P38 while incrementing pointer N by 1 in step P39 each time step P38 is performed. Steps P38 and P39 are repeated until N becomes equal to S1+1 (step P40), whereby absolute positions X(S1+S2−N+1) and origin positions G(S1+S2−N+1) of (S2+1)-th to S1-th upper knife holders 3U are transferred to program 20 in sequence.

Thereafter processing proceeds to step P71 shown in FIG. 9, and flag T is set to 2 in the manner described above, which represents that the upper knife holders 3U are in predetermined positions. The knife position setting processing is ended in step P76.

Thus, when the slitting width is to be narrowed and at the same time, the number of knives to be used is to be reduced from S1 to S2, first to S2-th upper knife holders 3U out of S1 upper knife holders 3U in the current position X(N) are moved to the respective next positions Y(N) in this order and S1-th to (S2+1)-th upper knife holders 3U are moved to the respective origin positions G(N) in this order.

In the case of switching where the number of knives used is increased, that is, when it is not determined that S1−S2>0 in step P36, steps P34 and P35 are repeated until N becomes equal to S1+1 (step P41), whereby absolute positions X(N) and Y(N) of first to S1-th upper knife holders 3U are all transferred to program 20 in sequence.

In the case of switching where the number of knives used is increased, after absolute positions X(N) and Y(N) of first to S1-th upper knife holders 3U are transferred to program 20, origin positions G(N) and absolute positions Y(N) of (S1+1)-th to S2-th upper knife holders 3U are transferred to program 20 as positions W(N) and Z(N) in sequence. (steps P42 to P44)

Thereafter processing proceeds to step P71 shown in FIG. 9, and flag T is set to 2 in the manner described above, which represents that the upper knife holders 3U are in predetermined positions. The knife position setting processing is ended in step P76.

Thus, when the slitting width is to be narrowed and at the same time, the number of knives to be used is to be increased from S1 to S2, first to S1-th upper knife holders 3U out of S1 upper knife holders 3U in the current position X(N) are moved to the respective next positions Y(N) in this order and (S1+1)-th to S2-th upper knife holders 3U in the respective origin positions G(N) are moved to the respective next positions Y(N) in this order.

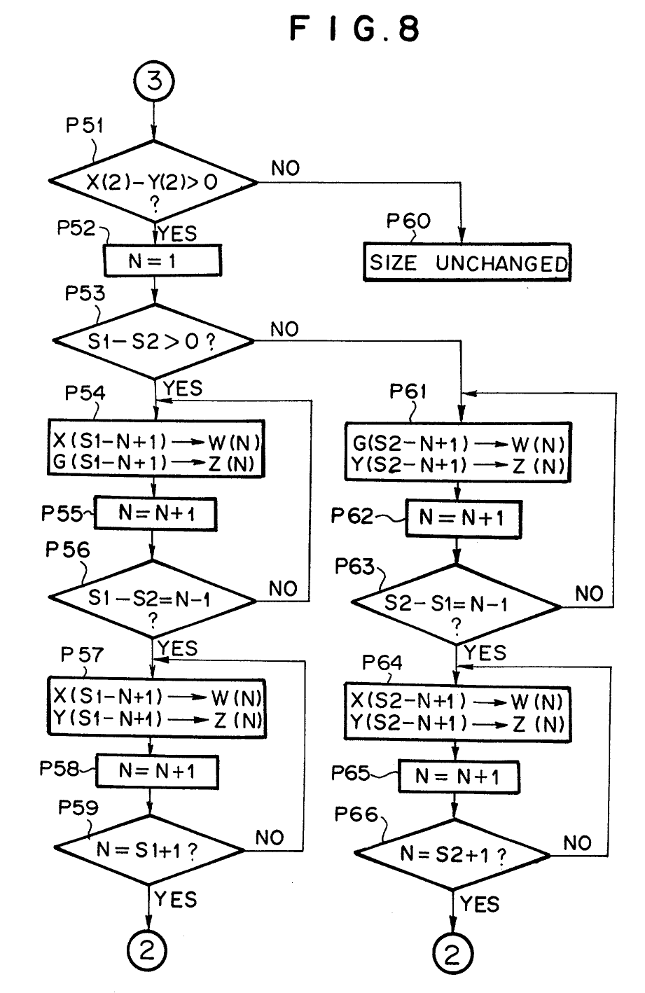

When it is determined in step P32 in FIG. 7 that X(2)−Y(2) is not smaller than 0, that is, in the case of switching where the slitting width is widened, processing proceeds to step P51 in FIG. 8. In step P51, it is determined whether X(2)−Y(2) is larger than 0. When it is determined that X(2)−Y(2) is not larger than 0, it is determined in step P60 that the slitting width is not changed.

When it is determined in step P51 that X(2)−Y(2) is larger than 0, pointer N is set to 1 in step P52 and then it is determined in step P53 whether S1−S2>0. When it is determined that S1−S2>0, that is, in the case of switching where the number of knives used is reduced, absolute position X(S1−N+1) and origin position G(S1−N+1) of a (S1−N+1)-th upper knife holder 3U, i.e., X(S1−N+1) and G(S1−N+1), are transferred to program 20 as positions W(N) and Z(N) in step P54 while incrementing pointer N by 1 in step P55 each time step P54 is performed. In the case of switching where the number of knives used is reduced, that is, S1−S2>0 (step P53), steps P54 and P55 are repeated until S1−S2 becomes equal to N−1 (step P56), whereby absolute positions X(N) and origin positions G(N) of S1-th to (S2+1)-th upper knife holders 3U are transferred to program 20 in sequence.

In the case of switching where the number of knives used is reduced, after absolute positions X(N) and origin positions G(N) of S1-th to (S2+1)-th upper knife holders 3U are transferred to program 20, absolute positions X(N) and Y(N) of S2-th to first upper knife holders 3U, i.e., X(S1−N+1) and Y(S1−N+1), are transferred to program 20 as positions W(N) and Z(N) in sequence.

That is, absolute positions X(S1−N+1) and Y(S1−N+1) of a (S1−N+1)-th upper knife holder 3U are transferred to program 20 as positions W(N) and Z(N) in step P57 while incrementing pointer N by 1 in step P58 each time step P57 is performed. Steps P57 and P58 are repeated until N becomes equal to S1+1 (step P59), whereby absolute positions X(N) and Y(N) of S2-th to first upper knife holders 3U are transferred to program 20 in sequence.

Thereafter processing proceeds to step P71 shown in FIG. 9, and flag T is set to 2 in the manner described above, which represents that the upper knife holders 3U are in predetermined positions. The knife position setting processing is ended in step P76.

Thus, when the slitting width is to be widened and at the same time, the number of knives to be used is to be reduced from S1 to S2, S1-th to (S2+1)-th upper knife holders 3U (S1−S2 in number) out of S1 upper knife holders 3U in the current position X(N) are moved to the respective origin positions G(N) in this order and S2-th to first upper knife holders 3U are moved to the respective next positions Y(N) in this order.

When it is determined in step P53 that S1−S2 is not larger than 0, that is, in the case of switching where the number of knives used is increased, origin position G(S1+N) and absolute position Y(S1+N) of a (S1+N)-th upper knife holder 3U, i.e., G(S1+N) and G(S1+N), are transferred to program 20 as positions W(N) and Z(N) in step P61 while incrementing pointer N by 1 in step P62 each time step P61 is performed. Steps P61 and P62 are repeated until S2−S1 becomes equal to N−1 (step P63), whereby origin positions G(N) and absolute positions Y(N) of (S1+1)-th to S2-th upper knife holders 3U are transferred to program 20 in sequence.

In the case of switching where the number of knives used is increased, after absolute origin positions G(N) and absolute positions Y(N) of (S1+1)-th to S2-th upper knife holders 3U are transferred to program 20, absolute positions X(N) and Y(N) of S1-th to first upper knife holders 3U, i.e., X(S2−N+1) and Y(S2−N+1), are transferred to program 20 as positions W(N) and Z(N) in sequence.

That is, absolute positions X(S2−N+1) and Y(S2−N+1) of a (S2−N+1)-th upper knife holder 3U are transferred to program 20 as positions W(N) and Z(N) in step P64 while incrementing pointer N by 1 in step P65 each time step P64 is performed. Steps P64 and P65 are repeated until N becomes equal to S2+1 (step P66), whereby absolute positions X(N) and Y(N) of S1-th to first upper knife holders 3U are transferred to program 20 in sequence.

Thereafter processing proceeds to step P71 shown in FIG. 9, and flag T is set to 2 in the manner described above, which represents that the upper knife holders 3U are in predetermined positions. The knife position setting processing is ended in step P76.

Thus, when the slitting width is to be widened and at the same time, the number of knives to be used is to be increased from S1 to S2, (S1+1)-th to S2-th upper knife holders 3U (S2−S1 in number) in the origin positions G(N) and S1-th to first upper knife holders 3U in the current positions X(N) are moved to the respective next positions Y(N) in this order.

Also in this embodiment, requirement toward an additional arrangement of the cutting knives can be easily attended to. That is, in this embodiment, requirement toward an additional arrangement of the cutting knives can be attended to by calculating positions to which the respective cutting knives are to be moved and order in which the cutting knives are moved without necessity of creating new programs.

What is claimed is;

1. In a slitter for slitting a wide sheet into a plurality of narrow strips by use of a plurality of cutting knives mounted on a shaft extending in a direction substantially normal to the direction in which the wide sheet is fed,
a method of switching cutting knife arrangements comprising the step of controlling a knife moving means to move the cutting knives along the shaft so that one of n-sorts of cutting knife arrangements in each of which the cutting knives are arranged in regular intervals is obtained, wherein the improvement comprises that
n-sets of knife positioning programs each for moving the cutting knives from respective origin positions to positions for the corresponding cutting knife arrangement and n-sets of knife returning programs each for returning the cutting knives from positions for the corresponding cutting knife arrangement to the respective origin positions are stored in a memory, and
when the cutting knife arrangements are switched from a first cutting knife arrangement to a second cutting knife arrangement, the cutting knives are once returned to the respective origin positions according to the cutting knife returning program for the first cutting knife arrangement and then moved to the positions for the second cutting knife arrangement according to the cutting knife positioning program for the second cutting knife arrangement.

2. In a slitter for slitting a wide sheet into a plurality of narrow strips by use of a plurality of cutting knives mounted on a shaft extending in a direction substantially normal to the direction in which the wide sheet is fed,
a method of switching cutting knife arrangements comprising the step of controlling a knife moving means to move the cutting knives along the shaft so that one of n-sorts of cutting knife arrangements in each of which the cutting knives are arranged in regular intervals is obtained, wherein the improvement comprises that
a set of program for controlling the knife moving means to move the cutting knives from one position to another along the shaft on the basis of given position information on positions from and to which the cutting knives are to be moved and order information on moving order in which the cutting knives are to be moved in sequence is stored in a memory, and
when the cutting knife arrangements are switched from a first cutting knife arrangement to a second cutting knife arrangement, position information and order information calculated on the basis of the first and second cutting knife arrangements are given to said program and the knife moving means is controlled on the basis of the program to move the cutting knives to positions for the second cutting knife arrangement.
